(19) United States
(12) Patent Application Publication
(10) Pub. No.: US 2014/0189284 A1
(43) Pub. Date: Jul. 3, 2014

(54) SUB-BLOCK BASED WEAR LEVELING

(71) Applicants: Nevin Hyuseinova, Barcelona (ES); Qiong Cai, Barcelona (ES)

(72) Inventors: Nevin Hyuseinova, Barcelona (ES); Qiong Cai, Barcelona (ES)

(21) Appl. No.: 13/992,636

(22) PCT Filed: Dec. 23, 2011
(86) PCT No.: PCT/US11/67218

§ 371 Date: Jun. 7, 2013

(51) Int. Cl. G06F 12/10

(52) U.S. Cl. CPC G06F 12/10
USPC 711/206

(57) ABSTRACT

Embodiments of the invention describe an apparatus, system and method for sub-block based wear leveling for memory devices. Embodiments of the invention may receive a write request to a physical memory address including a physical block address and a physical sub-block address. An address remapping table is accessed to translate the physical block address to a memory device block address to locate a plurality of memory device sub-blocks. A plurality of sub-block activity counters are accessed, each sub-block activity counter associated with one of the memory device sub-blocks. One of the plurality of memory device sub-blocks is selected to store write data of the write request based, at least in part, on values of the plurality of sub-block activity counters, and the value of the sub-block activity counter associated with the selected memory device sub-block is updated.

### FIELD

Embodiments of the invention generally pertain to computing devices and more particularly to sub-block based wear leveling for memory devices.

### BACKGROUND

For memory and storage devices whose memory cells can endure a limited number of write cycles, some cells might fail much earlier than the others due to uneven write traffic to cells by system applications. In this case, a device becomes unusable much sooner than the expected device lifetime, as expected device lifetimes are determined based on relatively even write usage of the cells. Examples of non-volatile memory devices with limited write endurance include flash memory, phase-change memory (PCM) and magneto-resistive random-access memory (MRAM).

Wear leveling is the approach of (relatively) evenly distributing writes across all device cells, thus extending the device lifetime. Typically it is achieved through dynamically re-mapping a physical address (i.e., the physical device addresses that would be used in the absence of wear leveling) to a different actual device address.

Wear leveling is particularly important and challenging for memory devices that operate as the memory of a computer system. Because the memory is relatively closer to the processor, ideal wear leveling processes are robust and efficient to handle high write traffic. They also have low performance cost and minimal write overhead. In addition, it is important for wear leveling processes to be highly secure against malicious attacks that compromise the security of the host system.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of a system memory to utilize an embodiment of the invention.

FIG. 2 is a diagram of a sub-block based wear leveling process according to an embodiment of the invention.

FIG. 3 is a flow chart describing a process for selecting a memory address mapping scheme according to an embodiment of the invention.

FIG. 4 is a flow chart describing a process for selecting a memory address mapping scheme according to an embodiment of the invention.

FIG. 5 is an illustration of platform hardware to utilize an embodiment of the invention.

FIG. 6 is block diagram of a system to utilize an embodiment of the invention.

FIG. 7A is a block diagram illustrating both an exemplary in-order pipeline and an exemplary register renaming, out-of-order issue/execution pipeline according to embodiments of the invention.

FIG. 7B is a block diagram illustrating both an exemplary embodiment of an in-order architecture core and an exemplary register renaming, out-of-order issue/execution architecture core to be included in a processor according to embodiments of the invention.

FIGS. 8A-B illustrate a block diagram of a more specific exemplary in-order core architecture, which core would be one of several logic blocks (including other cores of the same type and/or different types) in a chip.

FIG. 9 is a block diagram of a processor 800 that may have more than one core, may have an integrated memory controller, and may have integrated graphics according to embodiments of the invention.

FIG. 10 is a block diagram of an exemplary computer architecture according to an embodiment of the invention.

FIG. 11 is a block diagram of an exemplary computer architecture according to an embodiment of the invention.

FIG. 12 is a block diagram of an exemplary computer architecture according to an embodiment of the invention.

FIG. 13 is a block diagram of an exemplary computer architecture according to an embodiment of the invention.

FIG. 14 is a block diagram contrasting the use of a software instruction converter to convert binary instructions in a source instruction set to binary instructions in a target instruction set according to embodiments of the invention.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DESCRIPTION

Embodiments of an apparatus, system and method for sub-block based wear leveling for memory devices are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Embodiments of the invention may receive a write request to a physical memory address including a physical block address and a physical sub-block address. An address remapping table is accessed to translate the physical block address to a memory device block address to locate a plurality of memory device sub-blocks. A plurality of sub-block activity counters are accessed, each sub-block activity counter associated with one of the memory device sub-blocks. One of the plurality of memory device sub-blocks is selected to store write data of the write request based, at least in part, on values of the plurality of sub-block activity counters, and the value of the sub-block activity counter associated with the selected memory device sub-block is updated. Thus, embodiments of the invention track the wear-out status of sub-blocks within larger blocks in a cost efficient matter, thereby improving the efficiency of wear-leveling processes.

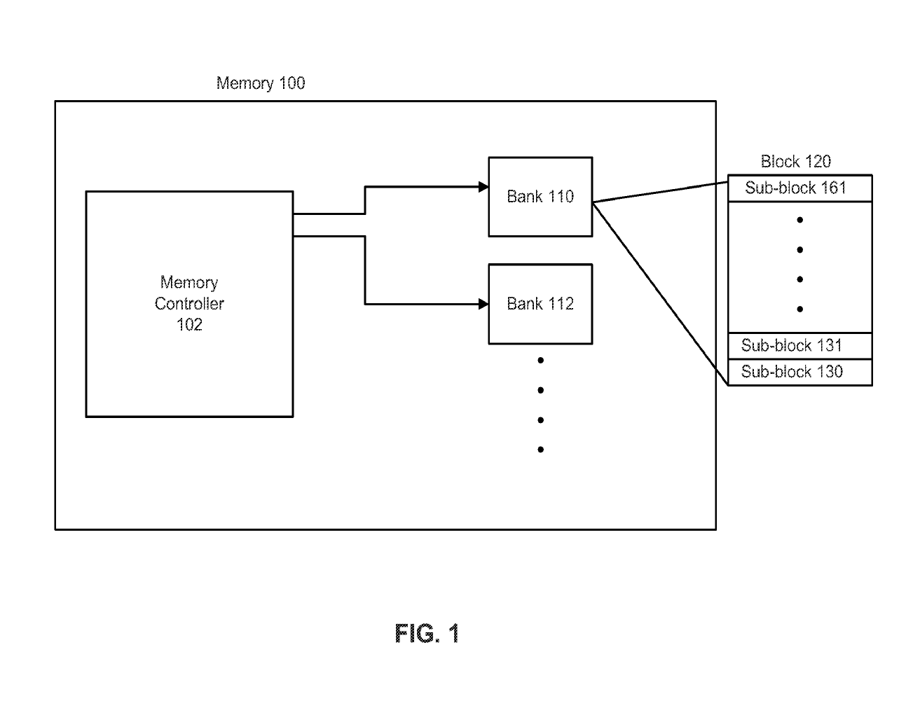

FIG. 1 is a block diagram of a system memory to utilize an embodiment of the invention. In this embodiment, memory system 100 includes memory controller 102 to control access to an array of memory banks (shown here as banks 110, 112 . . . ). Said memory banks may comprise NAND flash memories, NOR flash memories, Phase Change Memories (PCM), PCM comprised of arrays of phase change memory cells and switches (PCMS), magneto-resistive random-access memory (MRAM), silicon nanowire-based non-volatile memory cells, etc.

Each of said memory banks may include a plurality of blocks, each of which include a plurality of sub-blocks (e.g., block 120 including sub-blocks 130, 131 . . . 161). In this example, sub-blocks may comprise any size smaller than block 120 (e.g., block 120 may be a 4 k block comprised of 64 byte sub-blocks).

Embodiments of the invention describe wear leveling modules or logic to dynamically re-map a physical address (i.e., the physical device addresses that would be used in the absence of wear leveling) to a different actual device address based on a wear leveling algorithm. In order to translate between the physical address and the device address, an address remapping table (ART) (or any other suitable equivalent device, mechanism or process), is utilized. Embodiments of the invention update said ART based on activity tracking sub-blocks (e.g., sub-blocks 130, 131 . . . 161) as described below. Said ART holds physical to actual device address mappings in a block granularity that is larger than or equal to the read/write granularity of the device (i.e., sub-blocks). Managing the ART in a larger block granularity generally results in smaller hardware overhead, thus providing a robust and efficient wear-leveling solution to handle high write traffic.

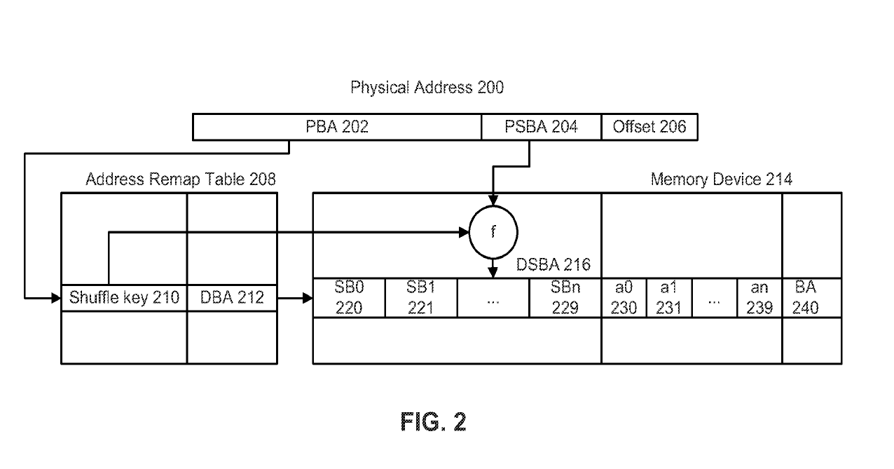

FIG. 2 is a diagram of a sub-block based wear leveling process according to an embodiment of the invention. In this embodiment, physical address 200 includes physical block address 202, physical sub-block address 204 and data offset 206.

Physical block address 202 points to a corresponding entry in ART 208, which includes device block address 212 and shuffle key 210. The architecture comprises a memory device with limited write endurance and an address remap table (ART) that can be implemented as a separate hardware structure or software allocated in the memory itself.

Embodiments of the invention obtain the actual memory device address through ART 208. Specifically, said device address is constructed by concatenating (1) the device block address (DBA) looked up from the ART, (2) device sub-block address (DSBA) 216, which is a function of PSBA 204 and shuffle key 210 maintained in the ART, and (3) the original data offset from the logical address of the operation. For example, PSBA 204 may be randomized based on a static randomization mapping. Then, the resulting value is xor-ed or modulo summed with the shuffle key. Because the shuffle key is changed each time the translation is modified, it helps for within-block wear leveling (i.e., sub-block wear leveling).

In this embodiment, the wear-leveling state of memory device 214 is tracked at sub-block granularity using saturating sub-block activity counters 220 (shown as a0 230, a1 231 . . . an 239), each of which correspond to one of the plurality of sub-blocks 218 (shown as SB0 220, SB1 221 . . . SBn 229). In some embodiments, a sub-block activity counter tracks the writes to the corresponding sub-block with a particular probability; avoiding update of the counters at every write operation is beneficial for reducing the storage requirement for activity counters and also for preventing the counters from becoming heavily written themselves.

In some embodiments of the invention, because a wear-leveling algorithm is in place, sub-blocks are presumed to wear out evenly. This allows for an approach to efficiently track hot sub-blocks using narrow-width activity counters (e.g. 1-, 2-, 4-bits wide), which in turn reduces the storage overhead of the implemented wear leveling process.

The variation across the activity counters 218 is an indication of whether the sub-blocks are wearing out evenly. For example, a large variation indicates hot-spot(s) in a subset of the sub-blocks. Once a hot spot is detected, embodiments of the invention may re-shuffle the sub-blocks of the block in order to achieve within-block wear leveling, or swap the whole block with another one to avoid excessive writes to the block in the future. In some embodiments, a shuffle threshold value is utilized in order to limit the number of sub-block shuffles before performing a block swap. The policy to select a second block for swap operation may vary (e.g., random logical block selection). In some embodiments, if the sub-blocks wear out evenly, sub-block re-shuffling is not triggered, but block swaps are performed periodically to ensure even wear out across all blocks in the memory device (e.g., by monitoring block activity counter 240). In one embodiment, the shuffle counter is utilized to control this periodic timing.

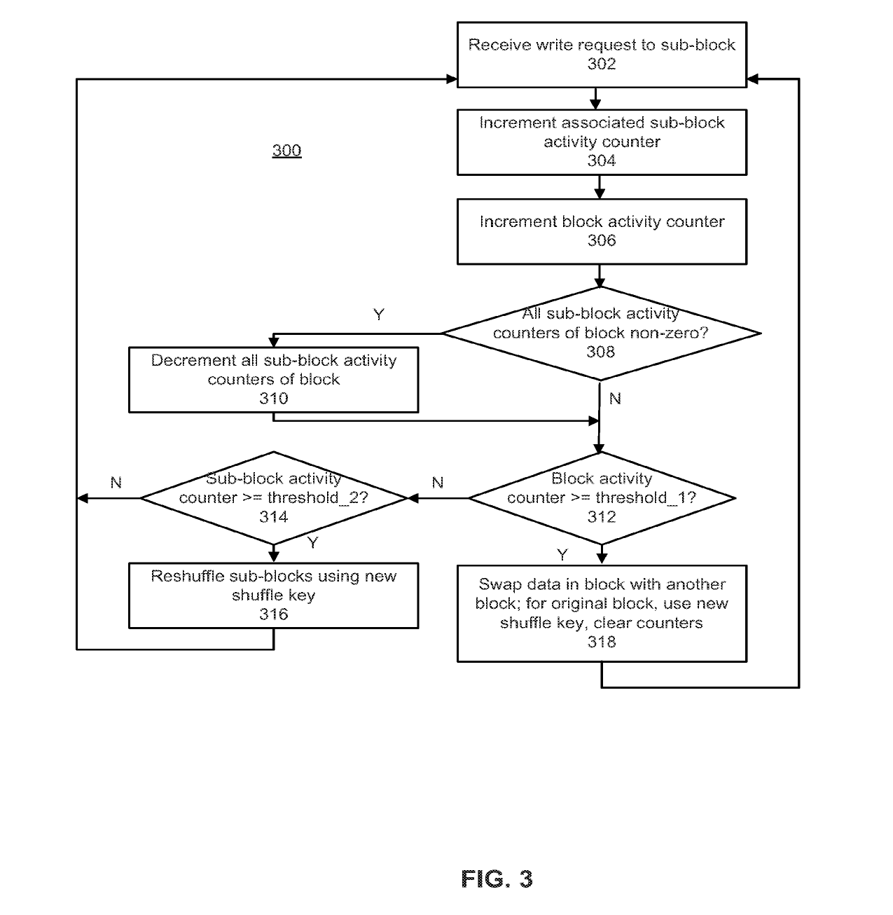

FIG. 3 is a flow chart describing a process for selecting a memory address mapping scheme according to an embodiment of the invention. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions may be performed in parallel. Additionally, one or more actions can be omitted in various embodiments of the invention; thus, not all actions are required in every implementation. Other process flows are possible.

Process 300 illustrates an example wear-leveling process. In this embodiment, all counters described below are initialized to zero, the activity counters of sub-blocks are incremented in a saturating manner and write operations are described to affect the memory device' wear leveling state.

Upon receiving a write request to a sub-block, 302, the associated sub-block activity counter is incremented, 304, and the associated block-activity counter (i.e., the activity counter of the block which includes said sub-block) is incremented, 306. In this embodiment, if all activity counters related to sub-blocks of the targeted block are non-zero, 308, all are decremented, 310, as the example algorithm need only detect the difference between the activity counters in a block; thus, in this embodiment, the minimum activity counter value for sub-blocks in the block is essentially anchored to zero in order to utilize narrow width activity counters. In other embodiments, multiple sub-blocks may share a single activity counter, which provides further storage overhead reduction.

If the block activity counter exceeds a threshold value related to block swap rate for even wear out (shown as threshold_{—}1), 312, then the data in the target block is swapped with another block, 318. This ensures excessive writes to this block are avoided. If said block activity counter does not exceed said threshold value, then sub-block wear-leveling processes are executed as described below.

If, a hot sub-block is identified—i.e., the associated activity counter is greater than or equal to a threshold value, 314, then the data is written to another sub-block of the block selected based on the new shuffle key, 316, ensuring excessive writes to sub-blocks are avoided.

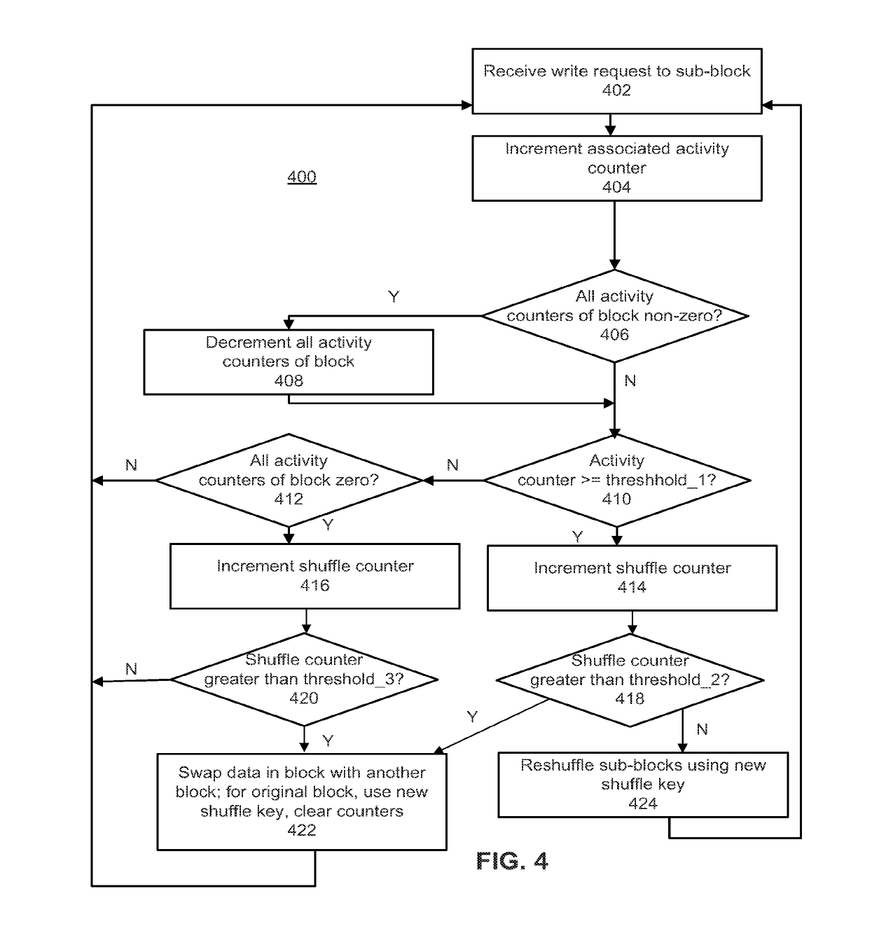

FIG. 4 is a flow chart describing a process for selecting a memory address mapping scheme according to an embodiment of the invention. Process 400 illustrates an example wear-leveling process. In this embodiment, all counters described below are initialized to zero, the activity counters of sub-blocks are incremented in a saturating manner and write operations are described to affect the memory device' wear leveling state.

Upon receiving a write request to a sub-block, 402, the associated activity counter is incremented, 404. In this embodiment, if all activity counters related to sub-blocks of the targeted block are non-zero, 406, all are decremented, 408, as the example algorithm need only detect the difference between the activity counters in a block; thus, in this embodiment, the minimum activity counter value for sub-blocks in the block is essentially anchored to zero in order to utilize narrow width activity counters. In other embodiments, multiple sub-blocks may share a single activity counter, which provides further storage overhead reduction.

If, a hot sub-block is identified—i.e., the associated activity counter is greater than or equal to a threshold value, 410, then the shuffle counter for the block is incremented, 414. If the write is not to a hot sub-block, it is determined if all counters have evened out (determined by checking if all counter values are zero, 412); if they have been evened out, the shuffle counter for the block is incremented, 416.

If the shuffle counter for the block exceeds a threshold value for controlling the number of shuffles (shown as threshold_{—}3), 420, then the data in the target block is swapped with another block, 422. For the original block, a new shuffle key is used, the activity counters are cleared, and address mappings are updated accordingly. This ensures excessive writes to this block are avoided. The above process similarly occurs if the shuffle counter for the block exceeds a threshold value related to block swap rate for even wear out (shown as threshold_{—}2), 418. If the shuffle counter for the block does not exceed the threshold value, the sub-blocks are re-shuffled to cause wear-leveling of the block, 424.

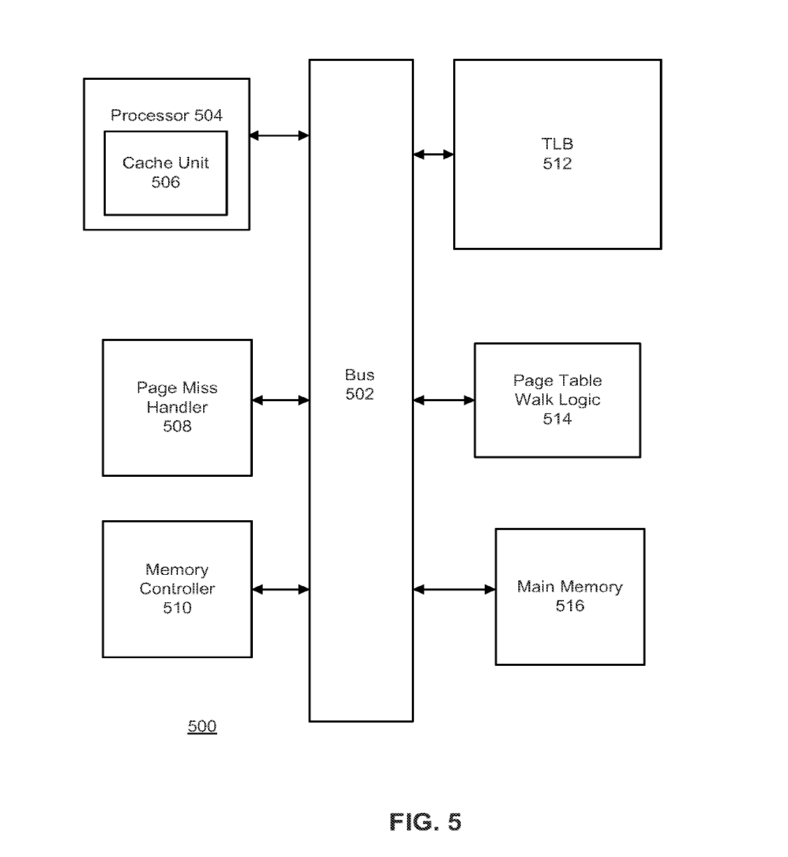

FIG. 5 is an illustration of platform hardware to utilize an embodiment of the invention. Platform hardware 500 is shown to include bus 502 communicatively coupling several other components to each other, including processor package 504 having cache unit 506, PMH 508, memory controller 510, TLB 512, page table walk logic 514 and main memory 516.

Processor 504 may include one or more processing cores to execute computer program instructions for the host system. Cache unit 506 may comprise a single or multi-level cache memory—e.g., a first level (L0) cache memory and a second level (L1) cache memory. Processor 504 generates instructions (alternatively referred to herein as micro-operations or “micro-ops”), such as memory loads, stores, and pre-fetches. The micro-ops may be in a sequence that differs from the sequence in which the instructions appear within a computer program. Micro-ops which involve memory accesses, such as memory loads, stores, and pre-fetches may be managed, at least in part, by memory controller 510.

In this embodiment, TLB 512 maintains a mapping of address translations between linear addresses and corresponding physical addresses. When a memory access type micro-op is loaded into an execution pipeline, it is intercepted by TLB 512, which performs a lookup to determine whether its internal cache lines contain the physical address corresponding to the linear address of the micro-op. If the address translation is found therein, i.e., if a hit occurs, TLB 512 re-dispatches a micro-op, updated to include the physical address. If a miss occurs, TLB 512 notifies PMH 508 that a page walk is to be performed via page table walk logic 514 to determine the physical address corresponding to the linear address of the micro-op.

As described above, wear leveling is achieved through dynamically re-mapping a physical address (i.e., the physical device addresses that would be used in the absence of wear leveling) to a different actual device address based on a wear leveling algorithm. Some embodiments of the invention translate the physical addresses into an actual device addresses at memory controller 510. In other embodiments of the invention, actual device address translation occurs right after the page-table-based linear to physical address translation in a manner transparent to the operating system or executive. For example, embodiments of the invention may implement the above described wear leveling algorithms at PMH 508. Upon a TLB miss, the PMH 508 walks the page table included in page table logic 514 to obtain the required physical address. Once successfully obtained, the PMH utilizes an above described wear leveling algorithm (i.e., sub-block based wear leveling) for the actual device address currently mapped to the physical address.

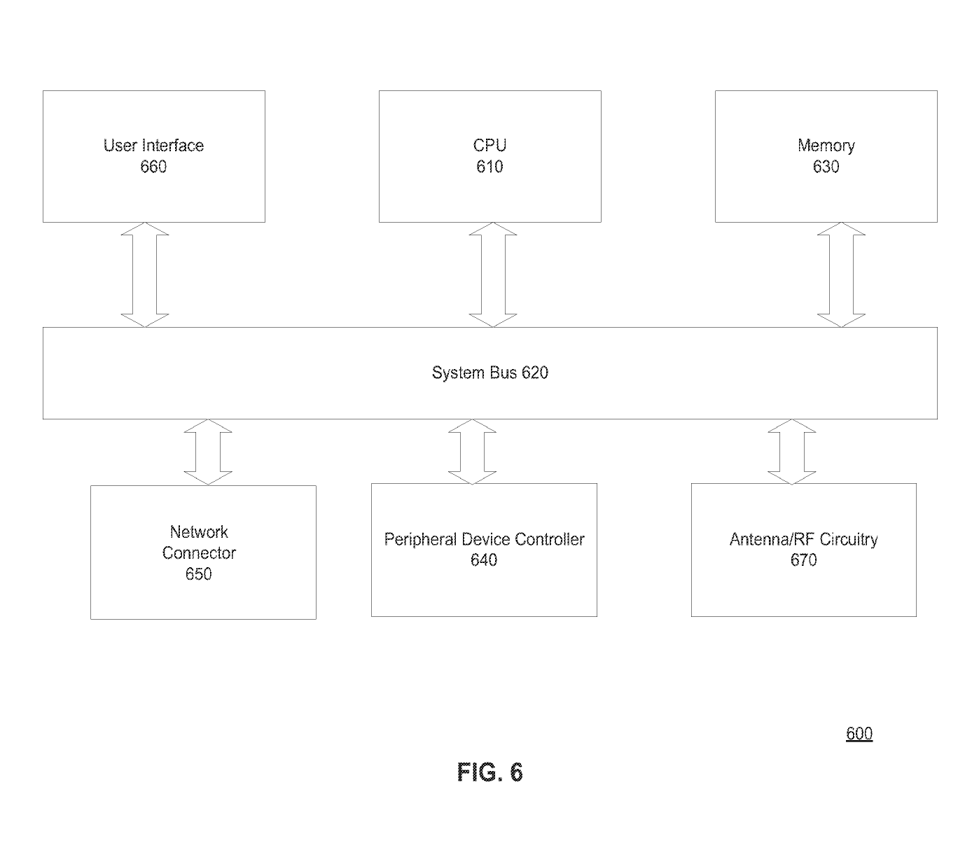

FIG. 6 is block diagram of a system to utilize an embodiment of the invention. System 600 may describe a server platform, or may be included in, for example, a desktop computer, a laptop computer, a tablet computer, a netbook, a notebook computer, a personal digital assistant (PDA), a server, a workstation, a cellular telephone, a mobile computing device, an Internet appliance, an MP3 or media player or any other type of computing device.

System 600 may include processor 610 to exchange data, via system bus 620, with user interface 660, system memory 630, peripheral device controller 640 and network connector 650. Said system memory may include NAND flash memories, NOR flash memories, PCM, PCMS, MRAM and silicon nanowire-based non-volatile memory cells, and subject to sub-block based wear-leveling according to any of the embodiments of the invention described above.

System 600 may further include antenna and RF circuitry 670 to send and receive signals to be processed by the various elements of system 600. The above described antenna may be a directional antenna or an omni-directional antenna. As used herein, the term omni-directional antenna refers to any antenna having a substantially uniform pattern in at least one plane. For example, in some embodiments, said antenna may be an omni-directional antenna such as a dipole antenna, or a quarter wave antenna. Also for example, in some embodiments, said antenna may be a directional antenna such as a parabolic dish antenna, a patch antenna, or a Yagi antenna. In some embodiments, system 600 may include multiple physical antennas.

While shown to be separate from network connector 650, it is to be understood that in other embodiments, antenna and RF circuitry 670 may comprise a wireless interface to operate in accordance with, but not limited to, the IEEE 802.11 standard and its related family, Home Plug AV (HPAV), Ultra Wide Band (UWB), Bluetooth, WiMax, or any other form of wireless communication protocol. In other embodiments, RF circuitry 670 may comprise cellular network connectivity logic or modules provided by wireless carriers, such as provided via GSM (global system for mobile communications) or variations or derivatives, CDMA (code division multiple access) or variations or derivatives, TDM (time division multiplexing) or variations or derivatives, or other cellular service standards.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

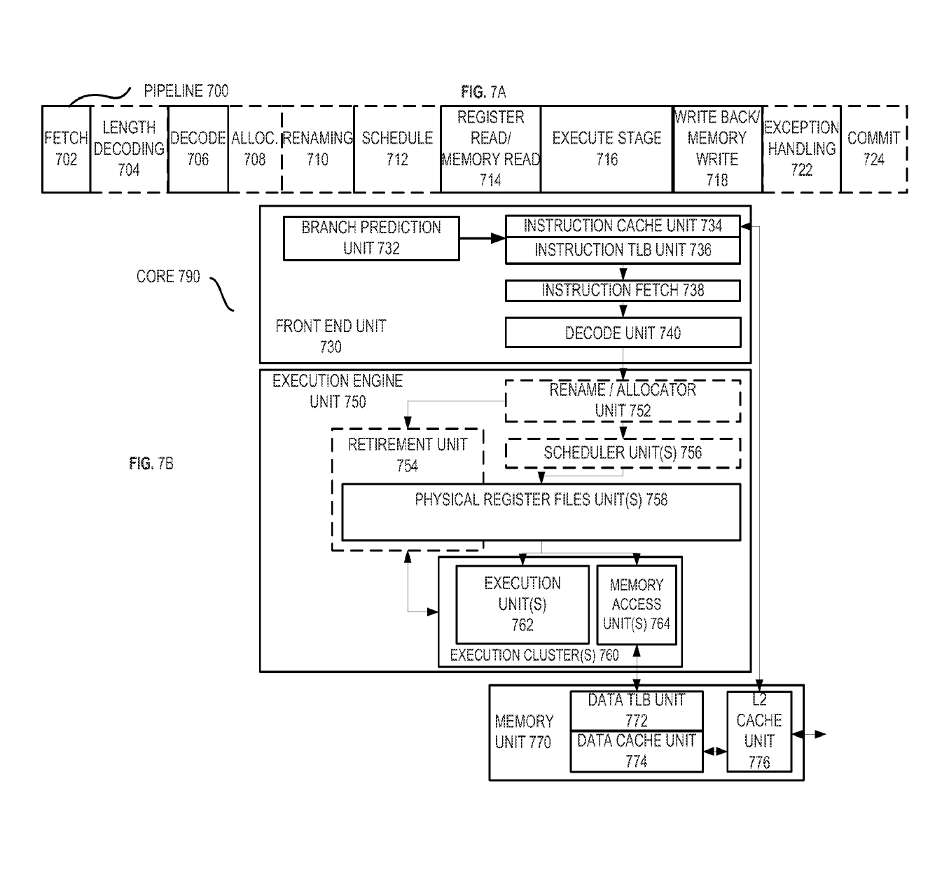

FIG. 7A is a block diagram illustrating both an exemplary in-order pipeline and an exemplary register renaming, out-of-order issue/execution pipeline according to embodiments of the invention. FIG. 7B is a block diagram illustrating both an exemplary embodiment of an in-order architecture core and an exemplary register renaming, out-of-order issue/execution architecture core to be included in a processor according to embodiments of the invention. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 758 comprises a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

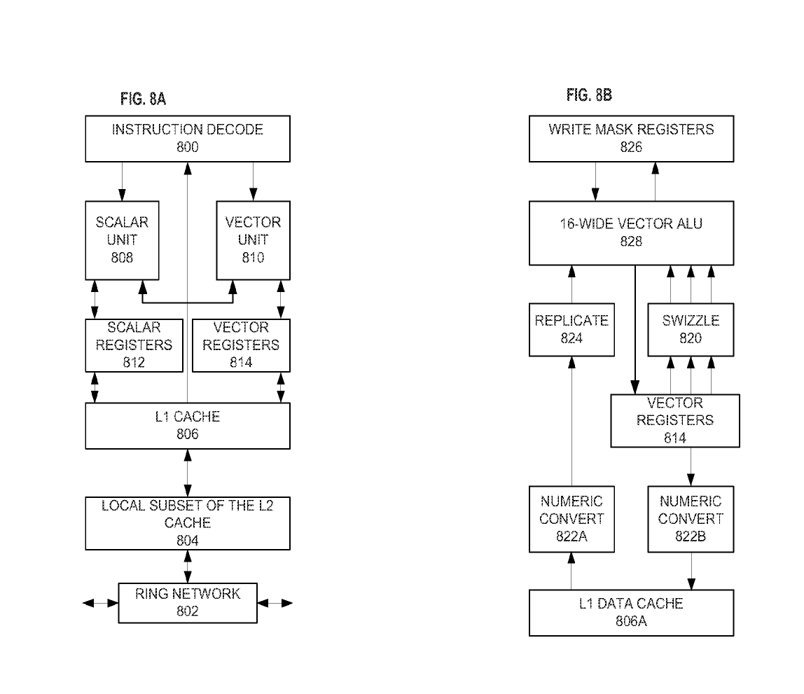

FIGS. 8A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 8A is a block diagram of a single processor core, along with its connection to the on-die interconnect network 802 and with its local subset of the Level 2 (L2) cache 804, according to embodiments of the invention. In one embodiment, an instruction decoder 800 supports the x86 instruction set with a packed data instruction set extension. An L1 cache 806 allows low-latency accesses to cache memory into the scalar and vector units. While in one embodiment (to simplify the design), a scalar unit 808 and a vector unit 810 use separate register sets (respectively, scalar registers 812 and vector registers 814) and data transferred between them is written to memory and then read back in from a level 1 (L1) cache 806, alternative embodiments of the invention may use a different approach (e.g., use a single register set or include a communication path that allow data to be transferred between the two register files without being written and read back).

The local subset of the L2 cache 804 is part of a global L2 cache that is divided into separate local subsets, one per processor core. Each processor core has a direct access path to its own local subset of the L2 cache 804. Data read by a processor core is stored in its L2 cache subset 804 and can be accessed quickly, in parallel with other processor cores accessing their own local L2 cache subsets. Data written by a processor core is stored in its own L2 cache subset 804 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 8B is an expanded view of part of the processor core in FIG. 8A according to embodiments of the invention. FIG. 8B includes an L1 data cache 806A part of the L1 cache 804, as well as more detail regarding the vector unit 810 and the vector registers 814. Specifically, the vector unit 810 is a 16-wide vector processing unit (VPU) (see the 16-wide ALU 828), which executes one or more of integer, single-precision float, and double-precision float instructions. The VPU supports swizzling the register inputs with swizzle unit 820, numeric conversion with numeric convert units 822A-B, and replication with replication unit 824 on the memory input. Write mask registers 826 allow predicating resulting vector writes.

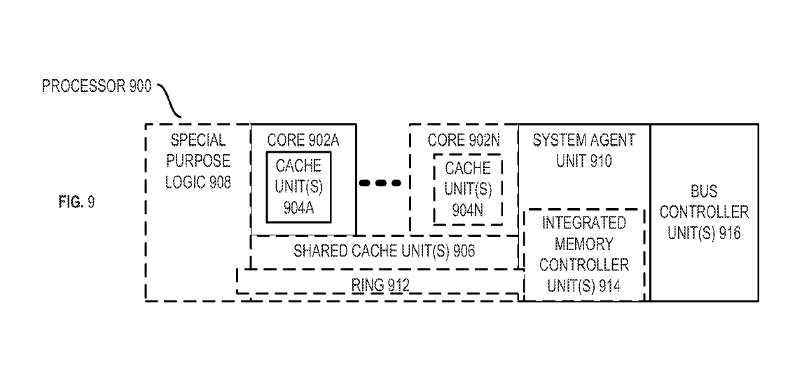

FIG. 9 is a block diagram of a processor 900 that may have more than one core, may have an integrated memory controller, and may have integrated graphics according to embodiments of the invention. The solid lined boxes in FIG. 9 illustrate a processor 900 with a single core 902A, a system agent 910, a set of one or more bus controller units 916, while the optional addition of the dashed lined boxes illustrates an alternative processor 900 with multiple cores 902A-N, a set of one or more integrated memory controller unit(s) 914 in the system agent unit 910, and special purpose logic 908.

Thus, different implementations of the processor 900 may include: 1) a CPU with the special purpose logic 908 being integrated graphics and/or scientific (throughput) logic (which may include one or more cores), and the cores 902A-N being one or more general purpose cores (e.g., general purpose in-order cores, general purpose out-of-order cores, a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 906, and external memory (not shown) coupled to the set of integrated memory controller units 914. The set of shared cache units 906 may include one or more mid-level caches, such as level 2 (L2), level 3 (L3), level 4 (L4), or other levels of cache, a last level cache (LLC), and/or combinations thereof. While in one embodiment a ring based interconnect unit 912 interconnects the integrated graphics logic 908, the set of shared cache units 906, and the system agent unit 910/integrated memory controller unit(s) 914, alternative embodiments may use any number of well-known techniques for interconnecting such units. In one embodiment, coherency is maintained between one or more cache units 906 and cores 902-A-N.

In some embodiments, one or more of the cores 902A-N are capable of multi-threading. The system agent 910 includes those components coordinating and operating cores 902A-N. The system agent unit 910 may include for example a power control unit (PCU) and a display unit. The PCU may be or include logic and components needed for regulating the power state of the cores 902A-N and the integrated graphics logic 908. The display unit is for driving one or more externally connected displays.

The cores 902A-N may be homogenous or heterogeneous in terms of architecture instruction set; that is, two or more of the cores 902A-N may be capable of execution the same instruction set, while others may be capable of executing only a subset of that instruction set or a different instruction set.

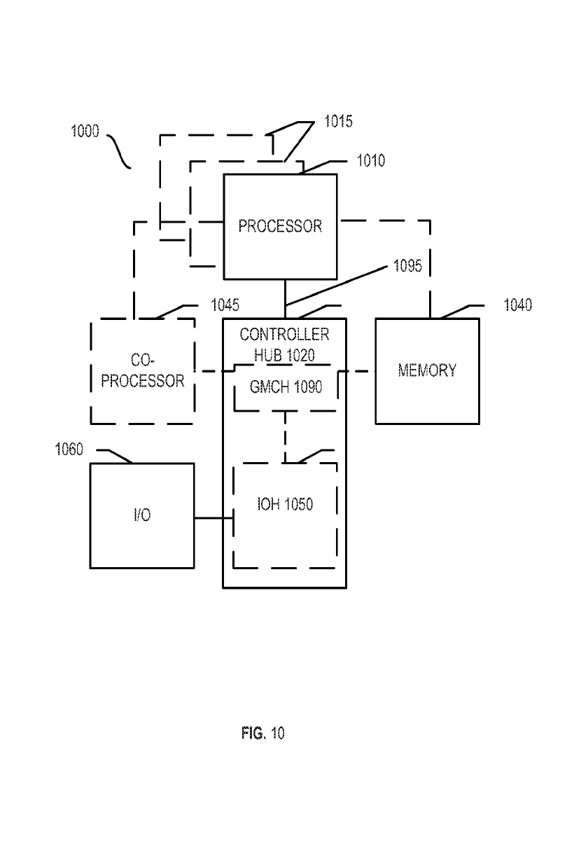

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 10, shown is a block diagram of a system 1000 in accordance with one embodiment of the present invention. The system 1000 may include one or more processors 1010, 1015, which are coupled to a controller hub 1020. In one embodiment the controller hub 1020 includes a graphics memory controller hub (GMCH) 1090 and an Input/Output Hub (IOH) 1050 (which may be on separate chips); the GMCH 1090 includes memory and graphics controllers to which are coupled memory 1040 and a coprocessor 1045; the IOH 1050 is couples input/output (I/O) devices 1060 to the GMCH 1090. Alternatively, one or both of the memory and graphics controllers are integrated within the processor (as described herein), the memory 1040 and the coprocessor 1045 are coupled directly to the processor 1010, and the controller hub 1020 in a single chip with the IOH 1050.

The optional nature of additional processors 1015 is denoted in FIG. 10 with broken lines. Each processor 1010, 1015 may include one or more of the processing cores described herein and may be some version of the processor 900.

The memory 1040 may be, for example, dynamic random access memory (DRAM), phase change memory (PCM), or a combination of the two. For at least one embodiment, the controller hub 1020 communicates with the processor(s) 1010, 1015 via a multi-drop bus, such as a frontside bus (FSB), point-to-point interface such as QuickPath Interconnect (QPI), or similar connection 1095.

In one embodiment, the coprocessor 1045 is a special-purpose processor, such as, for example, a high-throughput MIC processor, a network or communication processor, compression engine, graphics processor, GPGPU, embedded processor, or the like. In one embodiment, controller hub 1020 may include an integrated graphics accelerator.

There can be a variety of differences between the physical resources 1010, 1015 in terms of a spectrum of metrics of merit including architectural, microarchitectural, thermal, power consumption characteristics, and the like.

In one embodiment, the processor 1010 executes instructions that control data processing operations of a general type. Embedded within the instructions may be coprocessor instructions. The processor 1010 recognizes these coprocessor instructions as being of a type that should be executed by the attached coprocessor 1045. Accordingly, the processor 1010 issues these coprocessor instructions (or control signals representing coprocessor instructions) on a coprocessor bus or other interconnect, to coprocessor 1045. Coprocessor(s) 1045 accept and execute the received coprocessor instructions.

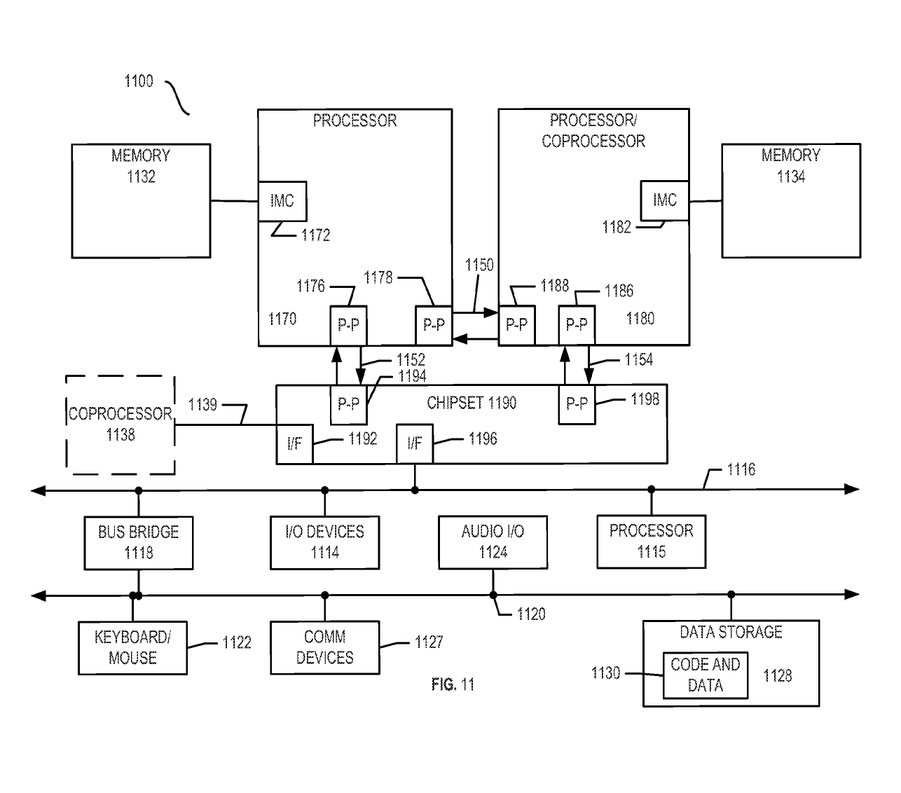

Referring now to FIG. 11, shown is a block diagram of a first more specific exemplary system 1100 in accordance with an embodiment of the present invention. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processor 900. In one embodiment of the invention, processors 1170 and 1180 arc respectively processors 1010 and 1015, while coprocessor 1138 is coprocessor 1045. In another embodiment, processors 1170 and 1180 are respectively processor 1010 coprocessor 1045.

Processors 1170 and 1180 are shown including integrated memory controller (IMC) units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1139. In one embodiment, the coprocessor 1138 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present invention is not so limited.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) units), field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to the second bus 1120. Note that other architectures are possible. For example, instead of the point-to-point architecture of FIG. 11, a system may implement a multi-drop bus or other such architecture.

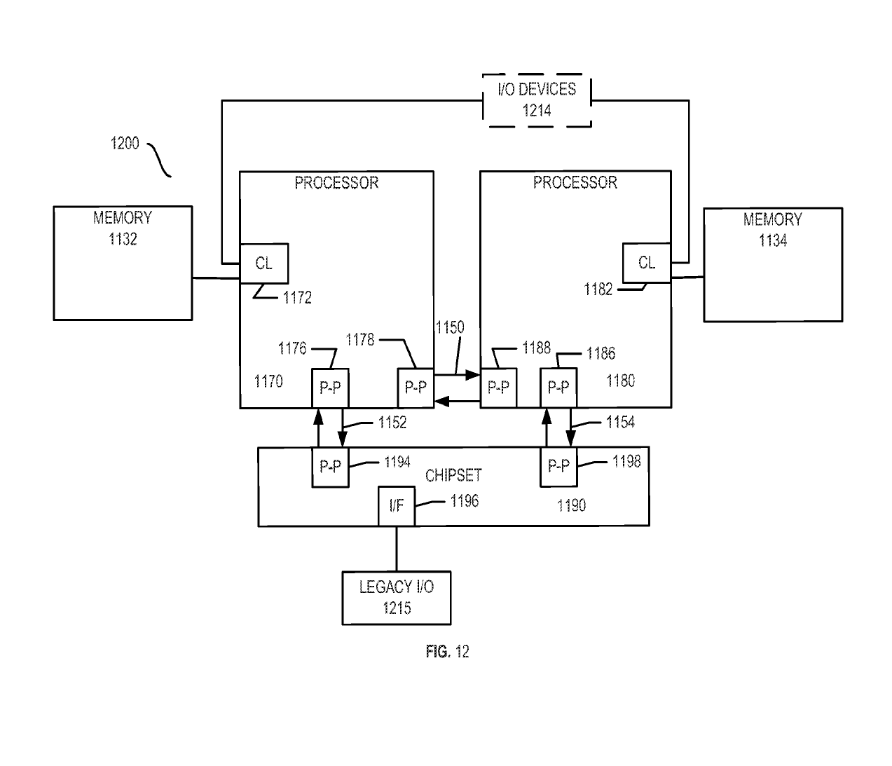

Referring now to FIG. 12, shown is a block diagram of a second more specific exemplary system 1200 in accordance with an embodiment of the present invention. Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processors 1170, 1180 may include integrated memory and I/O control logic (“CL”) 1172 and 1182, respectively. Thus, the CL 1172, 1182 include integrated memory controller units and include I/O control logic. FIG. 12 illustrates that not only are the memories 1132, 1134 coupled to the CL 1172, 1182, but also that I/O devices 1214 are also coupled to the control logic 1172, 1182. Legacy I/O devices 1215 are coupled to the chipset 1190.

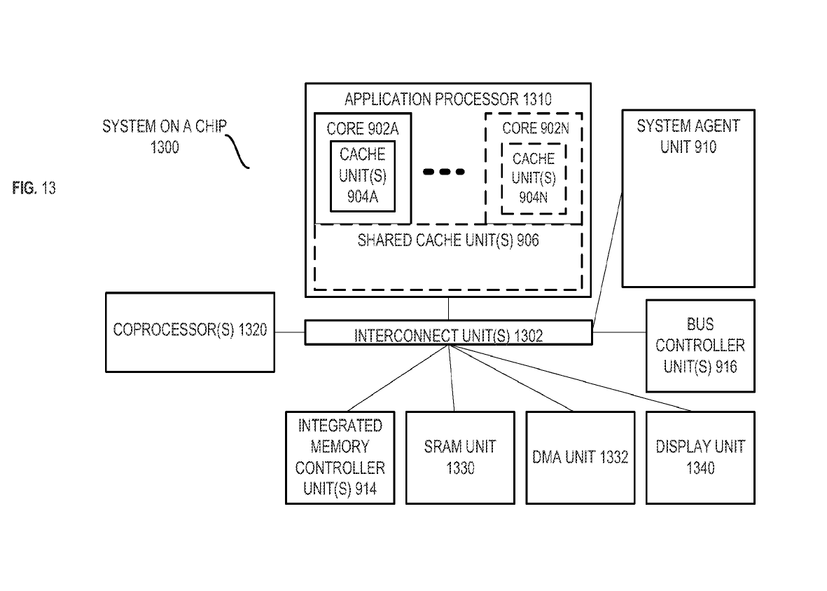

Referring now to FIG. 13, shown is a block diagram of a SoC 1300 in accordance with an embodiment of the present invention. Similar elements in FIG. 9 bear like reference numerals. Also, dashed lined boxes are optional features on more advanced SoCs. In FIG. 13, an interconnect unit(s) 1302 is coupled to: an application processor 1310 which includes a set of one or more cores 202A-N and shared cache unit(s) 906; a system agent unit 910; a bus controller unit(s) 916; an integrated memory controller unit(s) 914; a set or one or more coprocessors 1320 which may include integrated graphics logic, an image processor, an audio processor, and a video processor; an static random access memory (SRAM) unit 1330; a direct memory access (DMA) unit 1332; and a display unit 1340 for coupling to one or more external displays. In one embodiment, the coprocessor(s) 1320 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

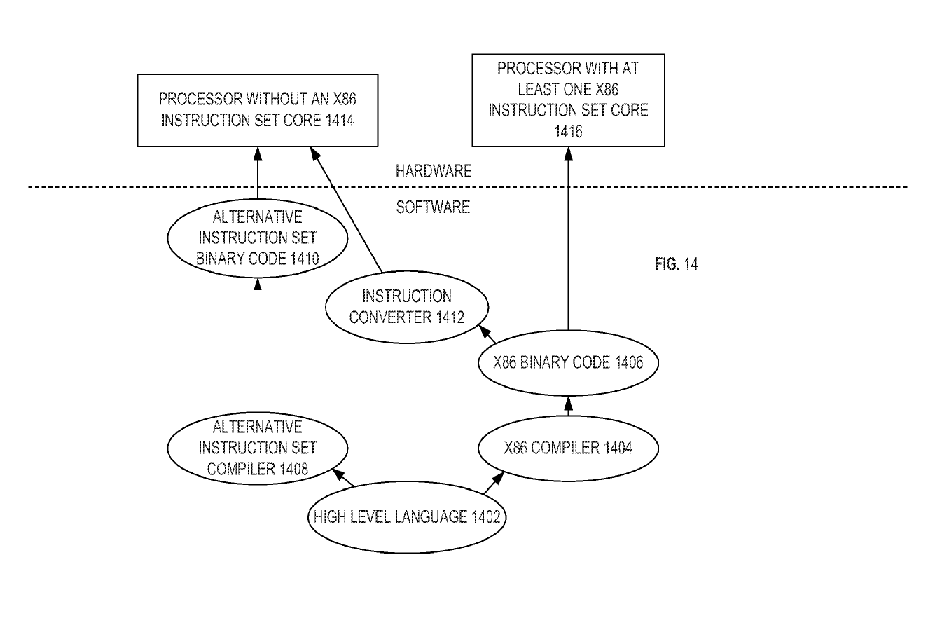

FIG. 14 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 14 shows a program in a high level language 1402 may be compiled using an x86 compiler 1404 to generate x86 binary code 1406 that may be natively executed by a processor with at least one x86 instruction set core 1416. The processor with at least one x86 instruction set core 1416 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1404 represents a compiler that is operable to generate x86 binary code 1406 (e.g., object code) that can, with or without additional linkage processing, be executed on the processor with at least one x86 instruction set core 1416. Similarly, FIG. 14 shows the program in the high level language 1402 may be compiled using an alternative instruction set compiler 1408 to generate alternative instruction set binary code 1410 that may be natively executed by a processor without at least one x86 instruction set core 1414 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1412 is used to convert the x86 binary code 1406 into code that may be natively executed by the processor without an x86 instruction set core 1414. This converted code is not likely to be the same as the alternative instruction set binary code 1410 because an instruction converter capable of this is difficult to make; however, the converted code will accomplish the general operation and be made up of instructions from the alternative instruction set. Thus, the instruction converter 1412 represents software, firmware, hardware, or a combination thereof that, through emulation, simulation or any other process, allows a processor or other electronic device that does not have an x86 instruction set processor or core to execute the x86 binary code 1406.

Various components referred to above as processes, servers, or tools described herein may be a means for performing the functions described. Each component described herein includes software or hardware, or a combination of these. Each and all components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration) may be provided via an article of manufacture including a non-transitory, tangible computer or machine readable storage medium, which provides content that represents instructions that can be executed. The content may result in a computer performing various functions/operations described herein.

A computer readable non-transitory storage medium includes any mechanism that provides (i.e., stores and/or transmits) information in a form accessible by a computer (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer readable non-transitory storage medium may also include a storage or database from which content can be downloaded. Said computer readable medium may also include a device or product having content stored thereon at a time of sale or delivery. Thus, delivering a device with stored content, or offering content for download over a communication medium may be understood as providing an article of manufacture with such content described herein.

1. A method comprising:
receiving a write request to a physical memory address including a physical block address and a physical sub-block address;
accessing an address remapping table to translate the physical block address to a memory device block address to locate a plurality of memory device sub-blocks;
accessing a plurality of sub-block activity counters, each sub-block activity counter associated with one of the memory device sub-blocks;
selecting one of the plurality of memory device sub-blocks to store write data of the write request based, at least in part, on values of the plurality of sub-block activity counters; and
updating the value of the sub-block activity counter associated with the selected memory device sub-block.

2. The method of claim 1, wherein the plurality of sub-block activity counters each comprise multi-bit counter values.

3. The method of claim 2, wherein selecting one of the plurality of memory device sub-blocks to store write data of the write request comprises:
determining which of the plurality of sub-block activity counters includes a maximum value; and
selecting a memory device sub-block not associated with the sub-block activity counter including the maximum value.

4. The method of claim 3, wherein selecting a memory device sub-block not associated with the sub-block activity counter including the maximum value comprises:
selecting a sub-block activity counter including a minimum value.

5. The method of claim 1, further comprising:
resetting each of the plurality of sub-block activity counters to an initial value in response to determining each of the plurality of sub-block activity counters includes the same value.

6. The method of claim 1, wherein the memory device comprises flash memory.

7. The method of claim 1, wherein the memory device comprises phase change memory (PCM).

8. An apparatus comprising:
a memory comprising a plurality of memory blocks, each memory block having a plurality of sub-blocks; and
a memory controller communicatively coupled to the memory device to:
receive a write request to a physical memory address including a physical block address and a physical sub-block address;
access an address remapping table to translate the physical block address to a memory device block address to locate the plurality of memory device sub-blocks;
access a plurality of sub-block activity counters, each sub-block activity counter associated with one of the memory device sub-blocks;
select one of the plurality of memory device sub-blocks to store write data of the write request based, at least in part, on values of the plurality of sub-block activity counters; and
update the value of the sub-block activity counter associated with the selected memory device sub-block.

9. The apparatus of claim 8, wherein the plurality of sub-block activity counters each comprise multi-bit counter values.

10. The apparatus of claim 9, wherein selecting one of the plurality of memory device sub-blocks to store write data of the write request comprises:
determining which of the plurality of sub-block activity counters includes a maximum value; and
selecting a memory device sub-block not associated with the sub-block activity counter including the maximum value.

11. The apparatus of claim 10, wherein selecting a memory device sub-block not associated with the sub-block activity counter including the maximum value comprises:
selecting a sub-block activity counter including a minimum value.

12. The apparatus of claim 8, the memory controller to further:
reset each of the plurality of sub-block activity counters to an initial value in response to determining each of the plurality of sub-block activity counters includes the same value.

13. The apparatus of claim 8, wherein the memory comprises flash memory.

14. The apparatus of claim 8, wherein the memory comprises phase change memory (PCM).

15. A system comprising:
a processor;
a data bus; and
a memory device to exchange data with the processor via the data bus, the memory device to include wear leveling logic to:
receive a write request to a physical memory address including a physical block address and a physical sub-block address;
access an address remapping table to translate the physical block address to a memory device block address to locate the plurality of memory device sub-blocks;
access a plurality of sub-block activity counters, each sub-block activity counter associated with one of the memory device sub-blocks;
select one of the plurality of memory device sub-blocks to store write data of the write request based, at least in part, on values of the plurality of sub-block activity counters; and
update the value of the sub-block activity counter associated with the selected memory device sub-block.

16. The system of claim 15, wherein the plurality of sub-block activity counters each comprise multi-bit counter values.

17. The system of claim 16, wherein selecting one of the plurality of memory device sub-blocks to store write data of the write request comprises:
determining which of the plurality of sub-block activity counters includes a maximum value; and
selecting a memory device sub-block not associated with the sub-block activity counter including the maximum value.

18. The system of claim 17, wherein selecting a memory device sub-block not associated with the sub-block activity counter including the maximum value comprises:
selecting a sub-block activity counter including a minimum value.

19. The system of claim 15, the wear leveling logic to further:
reset each of the plurality of sub-block activity counters to an initial value in response to determining each of the plurality of sub-block activity counters includes the same value.

20. The system of claim 15, wherein the memory device comprises flash memory.

21. The system of claim 15, wherein the memory device comprises phase change memory (PCM).
